(19) United States
(12) Patent Application Publication
(10) Pub. No.: US 2024/0109753 A1
(43) Pub. Date: Apr. 4, 2024

(54) ELEVATOR SAFETY SYSTEM

(71) Applicant: Otis Elevator Company, Farmington, CT (US)

(72) Inventor: Marcos Leon Atienza, Madrid (ES)

(21) Appl. No.: 17/988,470

(22) Filed: Nov. 16, 2022

(30) Foreign Application Priority Data
Sep. 30, 2022 (EP) 22382909.4

(51) Int. Cl. B66B 5/00; B66B 1/34; B66B 3/00

(52) U.S. Cl. CPC B66B 5/0062; B66B 1/3461; B66B 3/002; B66B 5/0068

(57) ABSTRACT

An elevator system (1) including at least one refuge space (7, 8) and at least one light curtain (9). The at least one light curtain (9) is configured to detect at least one object in the at least one refuge space (7, 8) and produce at least one safety signal (21) indicating the presence of the at least one object in the at least one refuge space (7, 8). The system can be used to improve the safety in the at least one refuge space (7, 8) in the event that the usual safety procedures have either failed or not been followed.

### FOREIGN PRIORITY

This application claims priority to European Patent Application No. 22382909.4, filed Sep. 30, 2022, and all the benefits accruing therefrom under 35 U.S.C. § 119, the contents of which in its entirety are herein incorporated by reference.

### TECHNICAL FIELD

This disclosure relates to a safety system for an elevator system. In particular, the disclosure relates to elevator systems with refuge spaces that can be accessed by people, for example maintenance workers.

### BACKGROUND ART

Elevator systems have areas that pose an increased level of risk and danger to people who occupy the space, but which must be accessed in order to perform maintenance work on the elevator system. Examples of such spaces include the top of the elevator car and the pit at the bottom of the elevator shaft.

These higher-risk areas can each have a corresponding refuge space, which is a space which can accommodate a person safely during an emergency. For example, when the elevator car is at its highest position in the elevator shaft, a refuge space may provide a sufficient gap between the roof of the elevator car and the top of the elevator shaft. This gap may be large enough for a person to stand, crouch, or lie in, and prevents them from being injured even when the elevator car is at its highest point in the elevator shaft. A similar refuge space can be provided between the bottom of the elevator car and the bottom of the elevator shaft when the elevator car is in its lowest position in the elevator shaft.

There are existing measures which are implemented in order to make these spaces safer for people who need to access them. For example, if a maintenance worker needs to access the top of the elevator car, there is a safety protocol to follow that should ensure that the elevator system is safe before they proceed to the top of the elevator car. Once on top of the elevator car, they will typically then activate an inspection switch. This places the elevator car into an “inspection mode” in which the elevator car can only be moved by the maintenance worker. Controls for moving the elevator car in the inspection mode are typically also on the roof of the elevator car.

However, there are problems with this system. In particular, it is possible for the other safety systems to fail. Alternatively, a maintenance worker who is busy or lazy may not fully or correctly follow the other safety procedures. If the other safety systems are not active for some reason, then the elevator car is placed in inspection mode, the elevator system may still be operational and thus it could be controlled (e.g. due to a new call) to move at full speed. There is then a risk of the person in the refuge space becoming trapped or injured.

### SUMMARY OF THE DISCLOSURE

According to a first aspect of the present disclosure, there is provided an elevator system, comprising: at least one refuge space; and at least one light curtain; wherein the at least one light curtain is configured to: detect at least one object in the at least one refuge space; and produce at least one safety signal indicating the presence of the at least one object in the at least one refuge space.

This system enables detection of objects in the refuge space of an elevator system without any action required by the object in the refuge space. This presents advantages over the safety systems currently known in the art.

For example, the system can be used to improve the safety in the refuge space in the event that the usual safety procedures have either failed or not been followed. For example, if for some reason the elevator system has not been placed into a safe state before a maintenance worker accesses the refuge space, the system will detect them and can produce a safety signal immediately indicating their presence in the refuge space.

Although it will be appreciated that light curtains are often installed so as to form a light barrier (or light sheet) that is oriented vertically (e.g. to detect a person passing through a doorway), a light curtain can have any orientation, i.e. the beam (or beams) of light may be directed at any orientation. For example, a light curtain may be oriented at any angle to the vertical. In particular, in many examples of this disclosure, the light curtain may be oriented horizontally or substantially horizontally. A vertical light curtain has a sensitivity over a larger height range while being restricted to a narrow floor area. A light curtain oriented away from the vertical (and especially closer to horizontal) has sensitivity over a larger floor area while being restricted to a narrower height range. In some examples, at least one light curtain is arranged at an angle of less than 45 degrees, optionally less than 30 degrees, optionally less than 15 degrees to the horizontal.

By detecting one or more interruptions in the light curtain, the light curtain can determine that a significant object (which may be a person) is present in the refuge space. The light curtain may be able to determine an amount of light in the curtain that has been obstructed and may therefore be able to determine an approximate size or dimension of the object that interrupted the light curtain. In addition, or alternatively, the elevator system may be able to determine the length of time that an interruption has taken. Such a determination may be made within the light curtain itself or it may be made by analysing the output signal from the light curtain, e.g. the determination may be made by an elevator controller. Such timing information can be used to avoid false positives from small debris (not a large enough obstruction to be considered a person) or from small items or falling or floating objects that pass through the beam only for a short time.

A light curtain may comprise an emitter part and a receiver part. The emitter part may produce a single wide beam of light or it may produce a plurality of beams of light. The plurality of beams of light could be directed in different directions, but in many common embodiments the plurality of beams of light are parallel. The beams of light travel towards, and are detected by, the receiver part. If an opaque object is placed between the emitter part and receiver part, the path of at least a portion of the light is blocked and the signal at the receiver part will be lower. The emitter part and receiver part may be the same part with the light being reflected off a reflector and back towards the emitter/receiver part. Alternatively, the emitter part and receiver part may be separate parts with the light being transmitted so that it travels from the emitter part to the receiver part, optionally via one or more intermediate reflectors. The light curtain may produce a safety signal that is dependent on the light received at the receiver part. The strength and/or distribution of the received light may indicate that an object is in the path of the light curtain and the safety signal may be generated accordingly.

The light curtain may emit a known amount of light and may be able to determine an amount or proportion of the light that has been obstructed (e.g. not reached a receiver part of the light curtain) and thereby determine a size of the object. The light curtain may emit a plurality of light beams and may be able to determine the number or proportion of beams that have been obstructed (e.g. not reached the receiver part of the light curtain) and thereby determine the size of the object. The receiver part may comprise an array of receivers. In such cases the light curtain may be able to determine which beams have been interrupted and may therefore be able to determine a dimension or an aspect of the shape of the object.

The elevator system can be any elevator system known in the art. The elevator system can be a roped system in which the elevator car is hoisted using e.g. ropes, chains or belts, or the elevator system may be lifted by hydraulics. The elevator car may also be ropeless, e.g. a beam climber system or a linear motor driven system. The elevator system can include any number of elevator cars and any number of elevator shafts. The elevator system can be configured to carry goods of any weight and/or size, and may comprise for example a passenger, service or freight elevator system or combinations thereof.

The refuge space is generally a small area of safety for a person to use during an emergency. In general, it is large enough for a single person either to stand, crouch, or lay down. Its dimensions can be dependent on local building codes and the size and age of the elevator system.

Any number of beams of light may be used in each light curtain. Equally, any number of receivers may be used in each light curtain. For example, a single wide beam may be sent by the emitter part and it may be received at a single common receiver in the receiver part. The amount of light received at the common receiver will vary with the size of any obstruction. In other examples, a plurality of beams of light may be sent by the emitter part and may be received by a single common receiver in the receiver part. Each beam of light that is obstructed will reduce the light received by the common receiver by a given amount. If each beam of light has the same intensity then the light received at the common receiver will be proportional to the number of beams that are unobstructed. This way a measure of size can be obtained. In other examples, a single beam or a plurality of beams may be sent by the emitter part and may be received by a plurality of receivers in the receiver part, e.g. an array of receivers. There may be a 1:1 correspondence between beams and receivers, although other ratios (x:1 or 1:x, x:y) are also feasible. The beams of light may be separated by any distance from each other along the length of the emitter part and receiver part. The distance between the receivers in the receiver part may be varied to obtain the desired resolution in the size of an object that may be detected by the light curtain. The smaller the distance between the receivers, the higher the resolution of the light curtain.

The light curtain may be located at floor level, e.g. just above the bottom of the refuge area. For example it may be arranged so that the curtain will be interrupted by any object resting on the floor of the refuge area. However, in some examples, the at least one light curtain is located at least 20 cm above the bottom of the refuge space, optionally at least 30 cm above the bottom of the refuge space, optionally at least 40 cm above the bottom of the refuge space. Spacing the curtain away from the floor allows the objects of smaller dimension to rest on the floor of the refuge space without interrupting the light curtain. This may be useful for differentiating between a maintenance worker that is a safety concern and small debris or a toolbox or an individual tool which is not a safety concern. This may help to reduce false alarms. The height at which the light curtain is located may be selected based on particular circumstances, e.g. based on the size of object that may typically be allowed to remain in the refuge space without safety concern.

In some examples, the at least one light curtain is located above the height of other objects that extend upwards from the bottom of the refuge space. These may be fixed objects that form part of the normal equipment of the elevator system, e.g. control boxes, electronic components (fuse boxes, fans, etc.) on top of the elevator car, or buffers or control equipment in the pit. Locating the light curtain at a height above such objects allows the light curtain to have greater coverage across the width of the elevator shaft without being interrupted by other equipment. In such examples, the light of the light curtain may be sent over the top of such equipment. It will be appreciated that the height may also be selected to ensure that a maintenance person will obstruct the light curtain when present. This may mean that some equipment cannot be avoided. In such cases, placement of the light curtain may be selected to avoid such equipment while keeping the light curtain at an appropriate height.

In some examples, the object that the light curtain detects is a person. Therefore, in such examples the light curtain may be placed at a height corresponding to a person stood upright (for example, at a height in a range corresponding to mid-torso to lower leg). In some examples, the light curtain is placed no less than 30 cm from the floor, optionally no less than 50 cm. It is also desirable to ensure that a person in a crouched position will still obstruct the light curtain and therefore the light curtain is in some examples located at a height no more than 100 cm, optionally no more than 70 cm above the bottom of the refuge space.

Light curtains can be made with varying widths, e.g. a varying number of parallel beams/receivers. A wider light curtain can cover a wider area and may be more suitable for general detection, while a narrow light curtain may cover a more specific area for specific detection. The light curtain may have a curtain width of at least 20 cm, optionally at least 40 cm, optionally at least 60 cm. The light curtain may in some examples have a width designed to ensure that a person standing or crouching at work in the refuge space is likely to obstruct at least some part of the light curtain.

It will be appreciated that the angle of the light curtain to the bottom of the refuge space may be varied to some degree, e.g. so that it will be obstructed by different height objects at different horizontal locations. This may be useful where there is one region of the refuge space where a maintenance worker would be expected to be upright (e.g. an entrance) and another region of the refuge space where they may be crouched (e.g. a control area). The angle may be a small angle selected for convenience of avoiding certain obstructions while maintaining a maximum distance of the curtain from the floor. However, in some examples the light curtain may be arranged to project its curtain substantially horizontally. This may be advantageous where the maintenance worker may be crouched or lying down at any point within the detection area as the maximum height of the curtain will remain substantially the same across the whole detection area.

The light curtain may be arranged to use light of any suitable wavelength. Although there could be some advantage to using visible light, e.g. as a visual safety reminder to the maintenance worker, in most examples it may be preferable that the light curtain is arranged to use light in a non-visible part of the electromagnetic spectrum, optionally infrared light. Using non-visible light avoids any distractions or dazzling of the maintenance working while they are working.

Multiple light curtains may be used in a single refuge space. In some examples, multiple light curtains may be used to provide detection over an irregular area. For example, if there is an obstruction in each corner of the refuge space, the remaining floor of the refuge space is cross-shaped. This cannot be covered by a single light curtain. Therefore, in some such examples, two perpendicular light curtains may be used in order to effectively cover the remaining area of the refuge space. In some such examples, the beams of light of the light curtains may overlap with one another.

More generally, the at least one light curtain may comprise a first light curtain and a second light curtain. It will be appreciated that further light curtains (e.g. third, fourth, etc.) may also be used. The first light curtain and the second light curtain may be arranged to point in the same direction (e.g. parallel to one another and/or non-overlapping) or they may be arranged to point in different directions (and may be overlapping or non-overlapping). The first light curtain and the second light curtain may be arranged at the same height or at different heights. It may be advantageous to have the first and second light curtains at the same height so that they have the same object detection capabilities, but this is not necessary. Where the first and second light curtains overlap, they may be at the same height, but they may also be at different heights depending on the available mounting space. Different height light curtains may also advantageously cover a larger range of heights, e.g. to provide some information about the size (height) of the object that has been detected based on whether one or both curtains have been obstructed. This may be used to distinguish between types of objects or to distinguish between a lying, crouching, or standing maintenance worker.

As noted above, the first light curtain and the second light curtain may be arranged to overlap above at least a portion of the bottom of the refuge space.

The first and second light curtains may be arranged in substantially the same plane or in substantially parallel planes (e.g. at different heights). In some examples, all such planes are substantially horizontal.

Where the first light curtain and the second light curtain are arranged to point in different directions, there may be an angle formed between them. The angle may be at least 30 degrees, at least 45 degrees or at least 60 degrees. The angle may be around 90 degrees such that the first and second light curtains are substantially perpendicular. Arranging the first and second light curtains in different directions can allow greater coverage of important areas of the refuge space and may allow better determination of the shape of a given obstruction by detecting different amounts of obstruction from different directions. This may help to distinguish between different types of object, e.g. to distinguish a tool box from a maintenance worker. It will be appreciated that such arrangements will be more capable of shape determination when the light curtains have a plurality of receivers for higher resolution. In some examples, the light curtain may have at least 10 receivers, optionally at least 25 receivers, optionally at least 50 receivers, optionally at least 75 receivers, optionally at least 100 receivers.

The response of the light curtain to an object in the refuge space can be binary or two-state, meaning that the output is either OFF or low, indicating no object is present, or the output is ON or high indicating the presence of an object in the refuge space. Alternatively, the response of the sensor to an object in the refuge space can be linear, meaning that the output is proportional to the size of the object in the dimension that obstructs the light curtain (the dimension parallel to the width of the light curtain). The output may be of any suitable form, e.g. a voltage output or a current output, etc.

In some examples, the elevator system may be arranged to send the safety signal only when the at least one object has been consistently detected for a predetermined period of time. In some such examples, the predetermined period of time may be sufficient that the signal from the receiver becomes consistently representative of an obstruction before producing the safety signal. This check ensures that an object is consistently blocking the signal between the emitter part and the receiver part. It may therefore prevent a safety signal from being produced when an object is only detected for a very short time, for example if an object is falling past the receiver. This may reduce the number of false alarms raised by the system. In some such examples, the predetermined period of time is no more than 3 seconds, optionally no more than 2 seconds, optionally no more than 1 second.

The safety signal can be any signal that is suitable for communicating information. For example, the safety signal could simply indicate the presence or absence of an object in the refuge space. In some examples, the safety signal can include more information, for example the location of the elevator system and/or the location of the light curtain. The safety signal can be sent in any conventional manner, for example over a wired connection or a wireless connection. The safety signal may be analogue or it may be a digital signal which may be encoded in a packet. For example, the safety signal may be sent over a wireless internet connection, short range wireless protocols such as Bluetooth, or as an analogue electrical signal.

It will be appreciated that the system may be configured to detect any object that blocks light. In many examples, the object will be a person or people, e.g. maintenance workers accessing the hoistway for inspection and/or repair. In some potentially overlapping examples, the object is inanimate, for example a toolbox or debris.

In some examples, the at least one refuge space comprises a refuge space on the top of the elevator car. The refuge space on top of the elevator car is generally a small area between the roof on the top of the elevator car and the top (ceiling) of the elevator shaft. The refuge space keeps a maintenance worker safe if the elevator car travels to the highest floor of a building.

The number of light curtains used can depend on a number of factors, including for example one or more of: the area of the floor (i.e. the size of the elevator car/elevator shaft); the shape of the refuge space; or the level of redundancy required. If there is a plurality of light curtains, they can work individually e.g. to detect objects in different positions in the refuge space (e.g. to detect one person in different places or to detect multiple people), or they can work together to provide a level of redundancy to the system e.g. to confirm that both light curtains are detecting an object, or to continue to provide a reading even if one light curtain fails.

In some examples, the at least one refuge space comprises a refuge space in the elevator pit. In such examples, the refuge space is generally a small area between the bottom of the elevator shaft and the bottom of the elevator car when it is at its lowest point in the hoistway. The refuge space keeps a maintenance worker safe when working in the elevator pit and when an elevator car travels to the lowest floor of the building.

In some examples, the refuge space comprises one or more flat regions, and the at least one light curtain is positioned in at least one of the flat regions. If a maintenance worker is working in the refuge space, they may be more likely to stand on at least one of the flat regions as this is more stable than a sloping or stepped section. Therefore, the light curtains may be more effective at detecting when a person is in the refuge space if they occupy at least one of the flat regions in the refuge space due to increased footfall in this area. In some examples, the flat regions may comprise an area at the entrance to the refuge space and/or a region in front of the control panels as these are areas most likely to be used.

In some examples, the elevator system comprises an elevator car having a crosshead, and wherein the at least one light curtain comprises a light curtain positioned on the crosshead. The crosshead is part of the frame around the elevator car which thus forms a raised section above the roof of the elevator car. The crosshead may be used as a platform during maintenance work due to its increased height. Therefore, a light curtain on the crosshead may be particularly useful for detecting when a person is in the refuge space even though they are not standing on the roof of the elevator car itself.

In some examples, the elevator system further comprises an elevator controller, configured to receive the safety signal from the light curtain wherein, upon receiving the safety signal from the light curtain, the elevator controller is configured to implement a safety response. In such examples, the elevator controller may comprise a processor and a memory. The elevator controller may be configured to operate one or more elevator cars.

In some examples, the safety response comprises an emergency stop. An emergency stop may include disconnecting the motor and brake from power, which results in the brake being applied. The elevator car is therefore stopped very rapidly, thereby reducing the risk to the person in the refuge space of the elevator system.

In some examples, the safety response comprises moving the elevator car at a reduced speed. Travelling at a lower speed ensures that the maintenance worker has more time to react if the elevator car starts moving, e.g. by putting the elevator system into inspection mode or pressing their emergency stop button. Additionally, it ensures a higher level of safety and comfort for any passengers currently inside the elevator car by reducing the magnitude of a sudden stop.

In some examples, the safety response comprises operating the elevator system in a pre-inspection operational mode. The pre-inspection operational mode can disable the elevator system so as to put it in a safe state. For example, it may prevent the elevator car from moving and/or may prevent it from servicing passenger calls. The inspection switch is operable by a maintenance worker, and is situated in the refuge space. After the inspection switch is activated, the elevator car can be operated in an inspection mode by controls in the refuge space, which will be discussed further below.

In some examples, the safety response comprises operating the elevator system in an inspection mode. When inspection mode is activated, only the maintenance worker can operate the elevator car. The controls to operate the elevator car during inspection mode are in the refuge space. During inspection mode, the elevator system cannot respond to hall calls or requests for service.

In some examples, the safety response comprises illuminating the at least one refuge space. In such examples, a light may be configured to increase visibility in order to aid maintenance work in the refuge space. In some potentially overlapping examples, a light is configured as a warning light used to alert the person in the refuge space that they are in an unsafe situation. In some examples, illuminating the refuge space may comprise illuminating the refuge space with a strong light sufficient for carrying out maintenance work. For example, the illumination may be at least 100 lux, at least 200 lux, or at least 500 lux. In some cases, low-level emergency or permanent lighting may already be present for safety reasons, but the safety response may comprise increasing the illumination level, e.g. to the levels mentioned above.

In some examples, the safety response comprises sending a signal to a communications centre or a building manager. In some examples, this signal comprises information about the event or emergency that triggered the signal. For example, the signal could include one or more of: the location of the elevator car (e.g. address or location inside the building, optionally including any of: a floor identifier, elevator car identifier, hoistway identifier, etc.); the number of objects detected, the size of object(s) detected and/or the location of the objects in the refuge space; or the status of the elevator car (e.g. whether it is moving, the door open/closed status, the inspection mode status, etc.). In some examples, the safety response can include making contact with the person in the refuge space, for example through an intercom system. The appropriate person can then ensure that further action is taken when necessary, for example making sure that the elevator system is placed in a suitably safe state and, in case that an unauthorized or unexpected access to the elevator shaft is detected, that the person or other object is removed from the refuge space safely.

In some examples, the elevator system further comprises a safety chain, configured to receive a safety signal from the light curtain. In some examples, upon receiving the safety signal from the light curtain, the safety chain is broken. Breaking the safety chain means that the overall state of the safety chain changes to indicate that a significant fault or incident has occurred. A safety chain may comprise a series of switches which are normally closed (conducting) such that the opening of any switch changes the safety chain to a non-conducting state. It will be appreciated that other arrangements of safety chain are possible. For example, breaking the safety chain could result in the safety chain becoming conductive rather than non-conductive. In some examples, when the safety chain is broken an emergency stop is initiated; however, the response can be any of those previously discussed. In some examples, the voltage of the safety signal matches that of a safety chain system (e.g. 48 V or 110 V in some examples). This can be achieved by suitable adaptation and modification of the output of the light curtain. This may be achieved by modifying a purchased (e.g. off-the-shelf and thus readily available, inexpensive) light curtain or designing a specific light curtain to operate in this manner. In some examples, the safety chain comprises a PESSRAL system (Programmable Electronic Systems in Safety Related Application for Lifts).

In some examples, the elevator controller is configured to operate an elevator system in a post-inspection mode when the safety signal is no longer received. This may be for example when the maintenance worker is leaving the refuge space or when another object is removed from the refuge space. In such examples, when the elevator system is in post-inspection mode it may be configured such that the elevator car cannot move or take any further passengers until the post-inspection mode is deactivated. In such examples, the post-inspection mode is similar to the pre-inspection mode discussed above and ensures safety (e.g. as a backup to other safety systems) after the inspection mode switch has been set to disable the inspection mode, until the refuge space is fully clear (e.g. until a maintenance worker has left the refuge space). Therefore, the process for a maintenance worker leaving the refuge space is the reverse of the process for entering the refuge space.

According to a second aspect of the present disclosure, there is provided a method of detecting objects in an elevator system comprising: detecting, by at least one light curtain, at least one object in at least one refuge space of the elevator system; producing, from the at least one light curtain, at least one safety signal indicating the presence of the at least one object in the at least one refuge space.

It will be appreciated that all of the features and advantages set out above in relation to the first aspect of the disclosure can equally be applied to the second aspect of the disclosure, i.e. they apply equally to the method of detecting objects in an elevator system.

### BRIEF DESCRIPTION OF THE DRAWINGS

Certain examples of the present disclosure will now be described with reference to the accompanying drawings in which:

FIG. 1 is a schematic view of an elevator system in accordance with an example of the present disclosure;

FIG. 2 is a schematic view of an elevator car with a light curtain in accordance with an example of the present disclosure;

FIG. 3 is a schematic view of an elevator car with light curtains in accordance with an example of the present disclosure;

FIG. 4 is a schematic view of an elevator car with a crosshead in accordance with an example of the present disclosure;

FIG. 5 is a schematic view of an elevator pit in accordance with an example of the present disclosure;

FIG. 6 is a block diagram of a light curtain system in accordance with an example of the present disclosure; and

FIGS. 7, 8, and 9 are flow charts showing methods of detecting objects in an elevator system in accordance with examples of the present disclosure.

### DETAILED DESCRIPTION

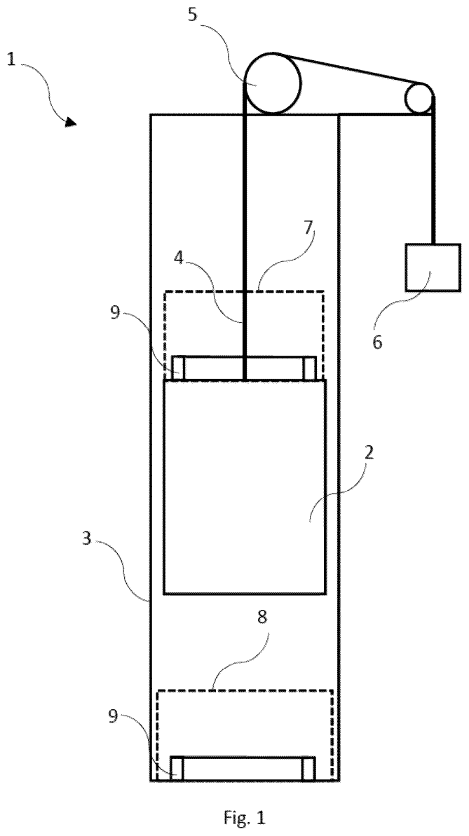

FIG. 1 shows a schematic view of an elevator system 1 according to an example of the present disclosure. The elevator system 1 includes an elevator car 2 arranged to move vertically in an elevator shaft 3. In this example, the elevator car 2 is connected by a rope 4 via a sheave 5 to a counterweight 6. The sheave 5 may be driven by a machine (not shown) so as to raise and lower the elevator car 2. It will be appreciated however, that the elevator system 1 can be operated by any suitable mechanism known in the art, including linear motors or beam climbers.

The elevator system 1 shown in FIG. 1 has two refuge spaces 7, 8. One refuge space 7 is on the roof of the elevator car 2. This refuge space 7 is used when the elevator car 2 is at its topmost position within the elevator shaft 3. When the elevator car 2 is in this position, the refuge space 7 must remain unobstructed so that a person can stand, crouch or lie (depending on the size of the refuge space 7) safely between the top of the elevator car 2 and the top of the elevator shaft 3.

The other refuge space 8 is at the bottom of the elevator shaft 3 (also called the elevator pit). This refuge space 8 is used when the elevator car 2 is at the bottom of the elevator shaft 3. When the elevator car 2 is at its lowermost position in the elevator shaft 3, it remains outside the refuge space 8 so that a person can stand, crouch or lie (depending on the size of the refuge space 8) safely between the bottom of the elevator shaft 3 and the bottom of the elevator car 2.

Where possible, it is advantageous to have both refuge spaces 7, 8 in the elevator system 1. In this example, each refuge space 7, 8 further includes a light curtain 9. The light curtain 9 can occupy the entire area of the refuge space 7, 8 or just a portion of it.

In some examples, the system 1 may have both refuge spaces 7, 8, but only one of the refuge spaces 7, 8 may have a light curtain 9 in it. In some other examples, the elevator system 1 may have a refuge space 7 on top of the elevator car 2, but no refuge space 8 in the elevator pit, while other examples may have a refuge space 8 in the elevator pit, but no refuge space 7 on top of the elevator car 2.

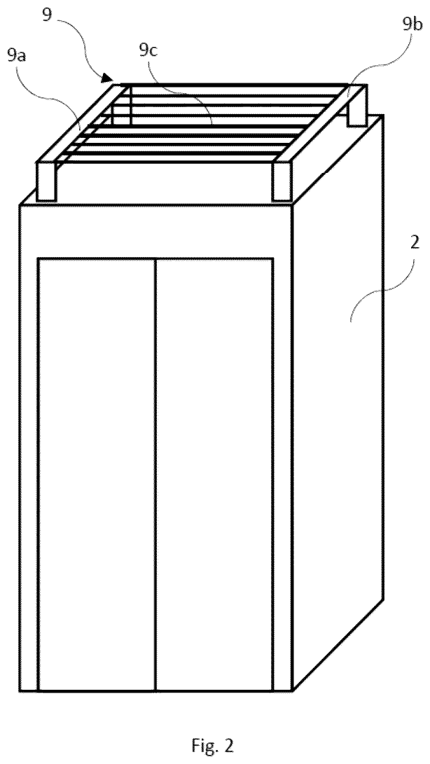

FIG. 2 shows a schematic view of an elevator car 2 with a light curtain 9. The light curtain 9 has an emitter part 9a and a receiver part 9b. A plurality of beams of light 9c travel from the emitter part 9a to the receiver part 9b. The number of beams of light shown in this example is purely illustrative. Although not shown, the receiver part 9b has an array of receivers, one for each light beam 9c. In this example, the light curtain 9 extends over substantially the entire area of the roof of the car 2. However, it will be appreciated that the light curtain 9 may be placed only in certain areas of importance or of high expected footfall. By way of illustration, one such example may include a light curtain 9 across the entrance to the refuge space and adjacent to a control panel (e.g. with an inspection mode switch, emergency stop switch and up and down control buttons).

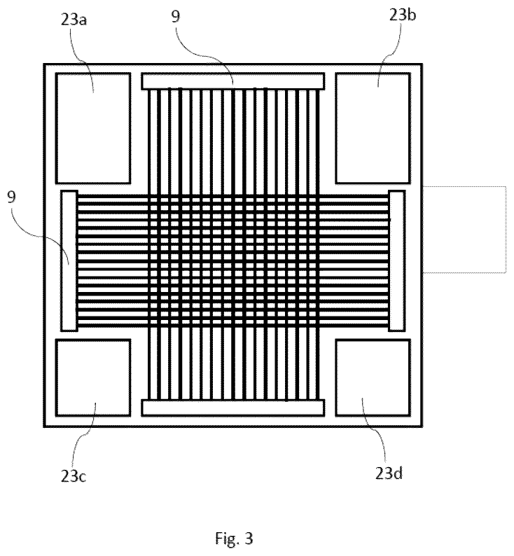

FIG. 3 shows a schematic view of a refuge space 7, 8 with light curtains 9 according to an example of the present disclosure. Although two light curtains 9 are shown, it will be appreciated that in other examples only one light curtain 9 may be provided or more than two light curtains 9 may be provided. In this example, there are obstructions 23a-d in the refuge space 7, 8, which may be for example a control panel, a buffer, ventilation equipment or other electrical or control equipment. The beams of light 9c from the light curtain 9 should not intersect with the obstructions 23a-d in order to ensure that all light transmitted by the emitter part is able to reach the corresponding receiver part.

In this example, there is an obstruction 23a-d at each corner of the refuge space 7, 8, meaning that the remaining floor of the refuge space 7, 8 is cross-shaped. This cannot be covered by a single light curtain. Therefore, in this example, two light curtains 9 are provided, with their respective curtains transmitted in different directions (substantially perpendicular here) in order to avoid obstructions 23a-d in the refuge space 7, 8 while effectively providing detection over the remaining area of the refuge space 7, 8. In this example, the beams of light 9c of the light curtains 9 overlap with one another. This does not affect the operation of the light curtains 9.

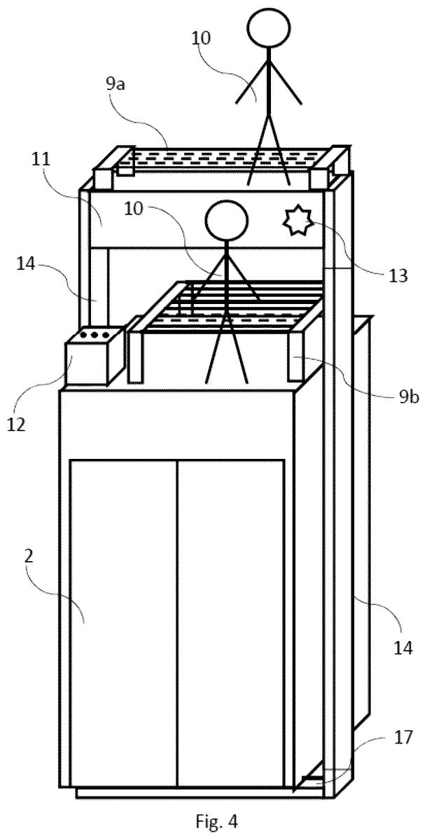

FIG. 4 shows a schematic view of an elevator car 2 with a crosshead 11, two light curtains 9a, 9b, a control panel 12, and a light 13 according to an example of the present disclosure. The crosshead 11 together with two uprights 14 and a structural plank 17 forms a support frame for the elevator car 2. The uprights 14 extend along the sides of the elevator car 2 and the structural plank 17 extends underneath the elevator car 2. The crosshead 11 may support various pieces of equipment or serve various functions (e.g. it may be the attachment point for a rope 4 or a sheave) but the crosshead 11 can also be used as a surface for standing on during maintenance work on the elevator system 1. Therefore, in this example a light curtain 9a is placed on the crosshead 11 in order to detect a maintenance worker 10 standing on the crosshead 11 in addition to a light curtain 9b on the roof of the elevator car 2. Two maintenance workers 10 are shown in FIG. 4 (which is not necessarily to scale) to illustrate detection by each of the two light curtains 9a, 9b. In this example, the broken/dashed lines represent beams of light that have been blocked between the emitter part and receiver part by the maintenance workers 10.

In this example, the second light curtain 9b on the roof of the elevator car 2 extends over the flat surfaces of the roof of the elevator car 2. It does not extend over any portions that are not flat, for example the control panel 12, because a maintenance worker 10 is less likely to stand in these portions of the refuge space 7.

The control panel 12 can include buttons and/or switches for the maintenance worker 10 to control movement of the elevator car 2. For example, the control panel 12 may enable the maintenance worker 10 to move the elevator car 2 up and down the elevator shaft 3 and perform an emergency stop. The control panel 12 can further include an inspection switch to place the elevator car 2 in an inspection mode, whereby only the maintenance worker 10 is able to control movement of the elevator car 2.

In this example, there is a light 13 installed on the crosshead 11. The light 13 can be installed anywhere in the refuge space 7, for example on the control panel 12, in the elevator shaft 3, or around either of the light curtains 9a, 9b. The light 13 can be used as part of the safety response to illuminate the refuge space 7, or as a warning light to let the maintenance worker 10 in the refuge space 7 know that they are in an unsafe situation or it may be used to provide (or to increase) illumination for working. In particular, the light 13 may provide an illumination in the refuge space 7 of at least 200 lux (preferably at least 300 lux or more). There may be a plurality of lights 13 (e.g. one on each side of the crosshead 11 or placed at different points on the roof of the elevator car 2), and they could perform either or both of the functions of illumination and warning. It will be appreciated that in some examples there may be one or more lights 13 for illumination and one or more lights 13 for warning.

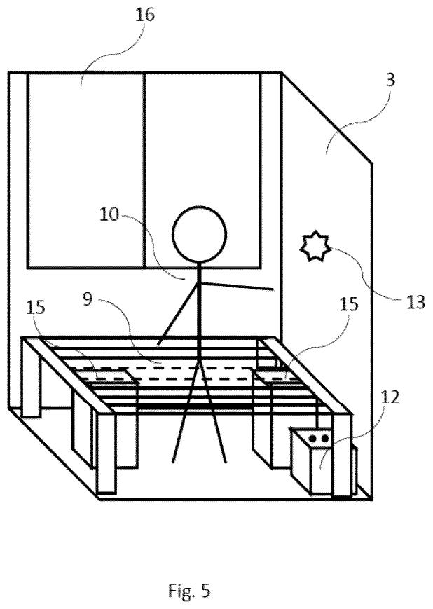

FIG. 5 shows a schematic view of the bottom of the elevator shaft 3 (also called the elevator pit) with a light curtain 9, a control panel 12, and buffers 15 according to an example of the present disclosure. The refuge space 8 at the bottom of the elevator shaft 3 is accessed by the hoistway doors 16 from the lowermost landing. The elevator pit may include various pieces of equipment such as buffers 15 and control panel 12 and it may include other obstructions not illustrated with the refuge space 8 provided between them or adjacent to them.

In this example, the emitter part and receiver part of the light curtain 9 are positioned at a height above the buffers 15 and the control panel 12. This ensures that beams of light of the light curtain 9 pass over the top of, and do not intersect with, the buffers 15 and control panel 12. As illustrated in this example, the light curtain 9 is still at a suitable height to detect a maintenance worker 10 in the refuge space 8. The broken/dashed lines represent beams of light that have been blocked between the emitter part and receiver part by the maintenance worker 10.

It will be appreciated that the same principle may be applied on top of the elevator car 2 as shown in FIG. 4. As discussed above, the light curtain 9 may be a single light curtain 9 or it may comprise a plurality of light curtains 9. Each light curtain may act as individual light curtain 9 with separate outputs, or they may all be connected together to act as a single sensor. The same principle also applies to the examples of FIG. 4.

It will be appreciated that in the above examples, while the light curtains 9 have been shown and described in relation to detection of a person such as a maintenance worker 10, the light curtains 9 are equally capable of detecting an inanimate object such as a toolbox or large debris. The number of receivers in the receiver part (and possibly also the beams of light) and the distance between them may be chosen to provide an appropriate level of resolution in the size of the object to be detected. For example, receivers spaced at small intervals may provide a higher level of resolution and enable the detection of smaller objects than receivers spaced at larger intervals.

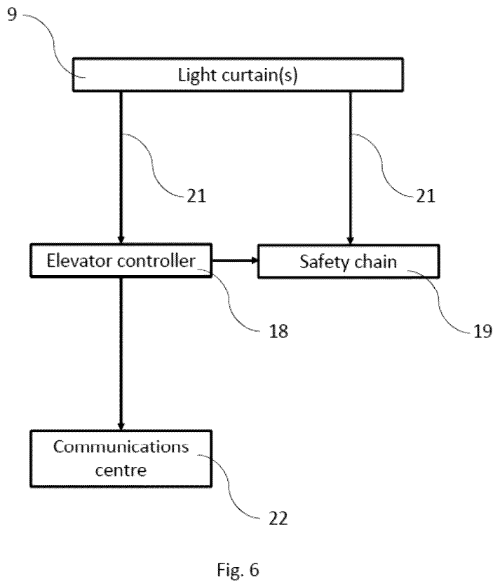

FIG. 6 schematically shows an elevator controller 18 and a safety chain 19 connected to the light curtain(s) 9 that can detect the presence of persons and/or other objects in the refuge spaces 7, 8. Upon detecting an object in the refuge spaces 7, 8, the light curtain(s) 9 produce and send a safety signal 21 to the elevator controller 18 and/or the safety chain 19 of the elevator system. The safety signal 21 initiates a suitable safety response, which can include one or more of the following actions: an emergency stop, moving the elevator car at a reduced speed; operating the elevator system in a pre-inspection mode; operating the elevator system in an inspection mode; illuminating the refuge space 7, 8 (e.g. via light 13); and/or sending a signal to a communications centre 22 or building manager. A safety signal 21 from the light curtain(s) 9 may directly break the safety chain 19, or in other examples a safety signal 21 from the light curtain(s) 9 may cause the controller 18 to generate a signal that breaks the safety chain 19 (which may be dependent on some further analysis by the controller 18 of the safety signal 21).

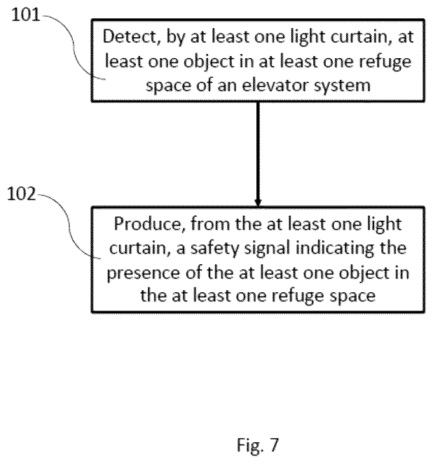

FIGS. 7, 8, and 9 are flow charts showing methods of detecting objects in an elevator system 1 according to various examples of the present disclosure.

In FIG. 7 at step 101 the object is detected by the light curtain 9 in the refuge space 7, 8. The light curtain 9 then produces a safety signal at step 102, which indicates the presence of an object in the refuge space 7, 8. The safety signal may include any amount of information about the object in the refuge space 7, 8. For example, it could be a simple on/off signal simply indicating that an object is present or absent or it could be a continuous value indicating the amount of light received at the receiver part (i.e. dependent on the amount of light blocked and therefore the size and/or number of the objects). It may also include further information such as the location and status of the elevator car 2.

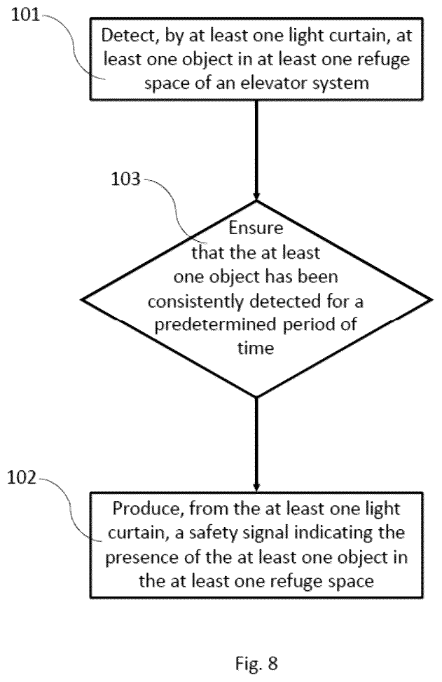

FIG. 8 shows an optional additional step to the method shown in FIG. 7. In these examples, the signal from the light curtain 9 may be checked over a predetermined period of time to ensure that it is consistently detecting at least one object. The predetermined period of time is sufficient that the signal from the receiver becomes consistently representative of an obstruction for a period of time before producing the safety signal. This step 103 ensures that an object is consistently blocking the signal between the emitter part and the receiver part. It may therefore prevent a safety signal from being produced when an object is only detected for a very short time, for example if an object is falling past the receiver. This may reduce the number of false alarms raised by the system. In some such examples, the predetermined period of time is no more than 3 seconds, optionally no more than 2 seconds, optionally no more than 1 second.

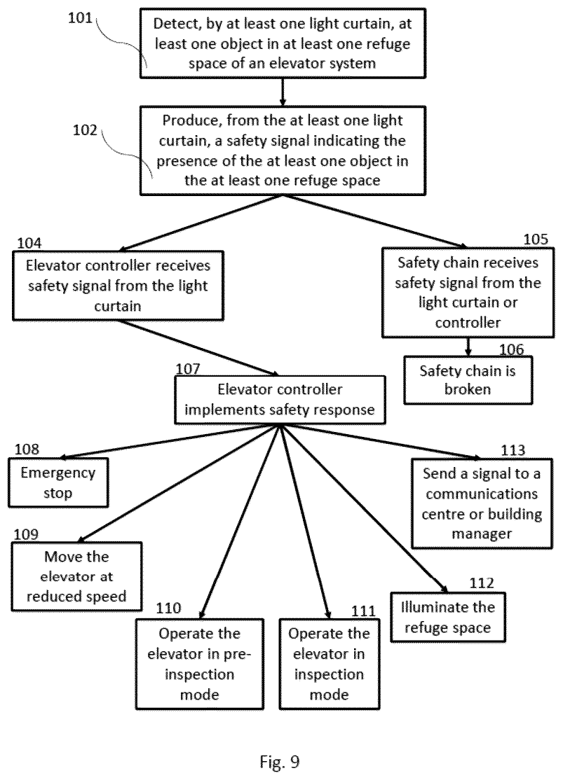

FIG. 9 shows further optional additional steps to the method shown in FIG. 7. In these examples, the safety signal is sent from the light curtain(s) 9 to an elevator controller in step 104 and/or to the safety chain in step 105. If the safety signal is sent to the safety chain (step 105), the safety response is to break the safety chain 106. This can cause an emergency stop of the elevator car 2 by causing power to be cut to the elevator drive and the elevator brake (which causes the brake to drop).

If the safety signal is sent to the elevator controller in step 104, the elevator controller then implements a safety response in step 107. The safety response can include one or more of the following actions: an emergency stop in step 108, moving the elevator car at a reduced speed in step 109; operating the elevator system in a pre-inspection mode in step 110; operating the elevator system in an inspection mode in step 111; illuminating the refuge space (e.g. via light 13) in step 112; and/or sending a signal to a communications centre or building manager in step 113.

It will be appreciated that some examples may include the process from step 104 onwards and not the process from step 105 onwards. Other examples may include the process from step 105 onwards and not the process from step 104 onwards. Other examples may include both options of steps 104 and 105, which may be activated simultaneously or may be triggered by different scenarios, e.g. based on different objects or a combination of the detected object together with other situational data.

Although not shown in FIG. 9, it will be appreciated that the optional step 103 of FIG. 8 may also be included in the examples of FIG. 9, between steps 101 and 102.

What is claimed is:

1. An elevator system (1), comprising:
at least one refuge space (7, 8); and
at least one light curtain (9);
wherein the at least one light curtain (9) is configured to:
detect at least one object in the at least one refuge space (7, 8); and
produce at least one safety signal (21) indicating the presence of the at least one object in the at least one refuge space (7, 8).

2. An elevator system (1) as claimed in claim 1, wherein the at least one refuge space (7) comprises a refuge space on the top of the elevator car (2); and/or
wherein the at least one refuge (8) space comprises a refuge space in the elevator pit.

3. An elevator system (1) as claimed in claim 1, wherein the elevator system (1) comprises an elevator car (2) having a crosshead (11); and
wherein the at least one light curtain (9) comprises a light curtain (9) positioned on the crosshead (11).

4. An elevator system (1) as claimed in claim 1, wherein the at least one light curtain (9) is located at least 20 cm above the bottom of the refuge space, optionally at least 30 cm above the bottom of the refuge space, optionally at least 40 cm above the bottom of the refuge space.

5. An elevator system (1) as claimed in claim 1, wherein the at least one light curtain (9) has a curtain width of at least 20 cm, optionally at least 40 cm, optionally at least 60 cm.

6. An elevator system (1) as claimed in claim 1, wherein the at least one light curtain (9) is arranged to project its curtain substantially horizontally.

7. An elevator system (1) as claimed in claim 1, wherein the at least one light curtain (9) comprises a first light curtain and a second light curtain.

8. An elevator system (1) as claimed in claim 7, wherein the first light curtain and the second light curtain are arranged to point in different directions; and/or
wherein the first light curtain and the second light curtain are arranged at different heights.

9. An elevator system (1) as claimed in claim 7, wherein the first light curtain and the second light curtain are arranged to overlap above at least a portion of the bottom of the refuge space.

10. An elevator system (1) as claimed in claim 1, wherein the elevator system (1) further comprises an elevator controller (18), configured to receive the at least one safety signal (21) from the at least one light curtain (9);
wherein, upon receiving the at least one safety signal (21) from the at least one light curtain (9), the elevator controller (18) is configured to implement a safety response.

11. An elevator system (1) as claimed in claim 10, wherein the safety response comprises one or more of:
an emergency stop;
moving an elevator car (2) at a reduced speed;
operating the elevator system (1) in a pre-inspection operational mode;
operating the elevator system (1) in an inspection mode;
illuminating (13) the at least one refuge space (7, 8); and
sending a signal to a communications centre (22) or a building manager.

12. An elevator system (1) as claimed in claim 10, wherein the elevator controller (18) is configured to operate the elevator system (1) in a post-inspection mode when the at least one safety signal (21) is no longer received.

13. An elevator system (1) as claimed in claim 1, wherein the elevator system (1) further comprises a safety chain (19) configured to receive the at least one safety signal (21) from the at least one light curtain (9);
wherein, upon receiving the at least one safety signal (21) from the at least one light curtain (9), the safety chain (19) is broken.

14. An elevator system (1) as claimed in claim 1, wherein the elevator system (1) is arranged to send the at least one safety signal (21) only when the at least one object has been consistently detected for a predetermined period of time.

15. A method of detecting objects in an elevator system (1) comprising:
detecting, by at least one light curtain (9), at least one object in at least one refuge space (7, 8) of the elevator system (1);
producing, from the at least one light curtain (9), at least one safety signal (21) indicating the presence of the at least one object in the at least one refuge space (7, 8).
